(19) United States
(12) Patent Application Publication
(10) Pub. No.: US 2014/0033228 A1
(43) Pub. Date: Jan. 30, 2014

(54) CONFIGURING CONTENT DISPLAY DIMENSIONS

(71) Applicant: Nathan Peter LUCASH, San Francisco, CA (US)

(72) Inventor: Nathan Peter LUCASH, San Francisco, CA (US)

(73) Assignee: Google Inc.

(21) Appl. No.: 13/558,182

(22) Filed: Jul. 25, 2012

(51) Int. Cl. G06F 9/54

(52) U.S. Cl. 719/313; 719/320

(57) ABSTRACT

Systems and methods of configuring content display dimensions via a computer network are provided. A request for content to display in an content item slot of a resource can be received via a computer network at a data processing system. The data processing system can determine, from the request, dimensions of the content item slot. Responsive to the request, the data processing system can select content for display in the content item slot. The content can include a script configured to execute at the resource. Based on information received from execution of the script, the data processing system can determine that the dimensions of the content item slot are greater than dimensions of the content. The data processing system can adjust the dimensions of the content item slot based on the dimensions of the content.

### BACKGROUND

In a networked environment such as the Internet or other networks, entities such as people or companies can provide information for public display, such as on web pages, documents, or other applications, etc. The Internet content can include text, video, or audio information provided by the entities via a web page server for display on the Internet. Additional content such as advertisements can also be provided by third parties for display on the web pages together with the information provided by the entities. Thus, a person viewing a web page can access the information that is the subject of the web page, as well as third party, self-promotional or in-house advertisements.

### SUMMARY

At least one aspect is directed to a computer-implemented method of configuring content display dimensions via a computer network. The method receives, at a data processing system, a request for content to display in a content item slot of a resource via the computer network. The method determines, from the request, dimensions of the content item slot. Responsive to the request, the method selects content for display in the content item slot. The content can include a script configured to execute at the resource. Based on information received from execution of the script, the method determines that the dimensions of the content item slot are greater than dimensions of the content. The method adjusts the dimensions of the content item slot based on the dimensions of the content.

At least one aspect is directed to a system of configuring content display dimensions via a computer network. The system includes a data processing system having a content placement circuit and a content sizing circuit. The data processing system can receive a request for content to display in a content item slot of a resource via the computer network. The data processing system can determine, from the request, dimensions of the content item slot. Responsive to the request, the data processing system can select content for display in the content item slot. The content can include a script configured to execute at the resource. Based on information received from execution of the script, the data processing system can determine that the dimensions of the content item slot are greater than dimensions of the content. The data processing system can adjust the dimensions of the content item slot based on the dimensions of the content.

At least one aspect is directed to a computer readable storage medium storing machine instructions to configure content display dimensions on a computer network. The instructions include instructions to receive a request for content to display in a content item slot of a resource via the computer network. The instructions include instructions to determine, from the request, dimensions of the content item slot. The instructions include instructions to select, responsive to the request, content for display in the content item slot. The content can include a script configured to execute at the resource. Based on information received from execution of the script, the instructions include instructions that can determine that the dimensions of the content item slot are greater than dimensions of the content. The instructions include instructions to adjust the dimensions of the content item slot based on the dimensions of the content.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting an example system of configuring content display dimensions via a computer network, according to an illustrative implementation;

FIG. 2 is a flow diagram depicting a method of configuring content display dimensions via a computer network, according to an illustrative implementation; and

FIG. 3 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and embodiments of, methods, apparatuses, and systems for configuring content display dimensions of resource (e.g., web page) components such as a content item slot on a computer network. The various concepts introduced above and discussed in greater detail below may be implemented in any of numerous ways, as the described concepts are not limited to any particular manner of implementation. Examples of specific implementations and applications are provided primarily for illustrative purposes.

A computing device (e.g., a user device) can view a resource such as a web page via the Internet by communicating with a web page server corresponding to that web page. The web page can include content that is the subject of the web page, as well as additional content such as advertisements. In one implementation, responsive to receiving a request to access the web page, the web page server can communicate with a data processing system such as an ad placement system to request an advertisement or other content for insertion into the rendering of the web page displayed at the computing device. The ad placement system can select the appropriate advertisement and provide it to the web page server for display with the web page.

In another implementation, the web page server may provide webpage data to the computing device, which may include one or more advertisement tags. An advertisement tag can be any piece of webpage code associated with placing an advertisement into a content item slot (e.g., an ad slot) of a webpage. In this implementation, the advertisement tags may cause the computing device to make a request for advertisement. The ad placement system can identify an advertisement and provide the advertisement to the computing device for display with the web page. In another implementation, an advertisement can be cached locally on the computing device. When the computing device makes a request for an advertisement, the ad server may not need to send the advertisement again if it is the same advertisement. The locally cached advertisement can be combined with the web page for display. In another implementation, the system that serves the advertisement (e.g., an ad server) and the system that selects the advertisement can be separate entities. For example, an ad server can be responsible for serving the advertisement to the computing device while another entity (e.g., an advertiser) can be responsible for selecting the advertisement for display.

A content publisher can set aside a space on a resource such as a web page for display of an advertisement. For example, a web page can include at least one content item slot, having length and width dimensions and other properties (e.g., type, format, font size, etc.). A content item slot may be an area of a web page or application that is made available for displaying content. In one implementation, a content item slot includes at least one ad slot. When a data processing system such as an ad placement system receives a request for content such as advertisements, the dimensions of the content item slot can be specified in the request. The ad placement system can identify suitable advertisements based at least in part on the size of the content item slot, and can select the identified advertisements for display with a web page at the user device that originated the request.

The dimensions of the advertisement selected for display might not match the dimensions of the content item slot. For example, if the dimensions of the content item slot are 200×200 pixels (“px”) and the size of the advertisement selected is 200 px×170 px, the advertisement does not fill the entire content item slot and in this example there is a swath of trailing whitespace (e.g., 200 px×30 px) in the unused portion of the content item slot when the web page is displayed with the advertisement.

The systems and methods described herein can adjust dimensions of the content item slot based on dimensions of the advertisement selected by the ad placement system. For example, a data processing system can determine that a content item slot has unused space, and can resize the content item slot to remove the unused space from the ad slot, where it can become available for the display of additional content on the web page. With reference to the above example, the content item slot dimensions can be adjusted to remove the 200 px×30 px of unused content item slot space from the content item slot. This web page area can be used for the display of web page content or additional advertisements.

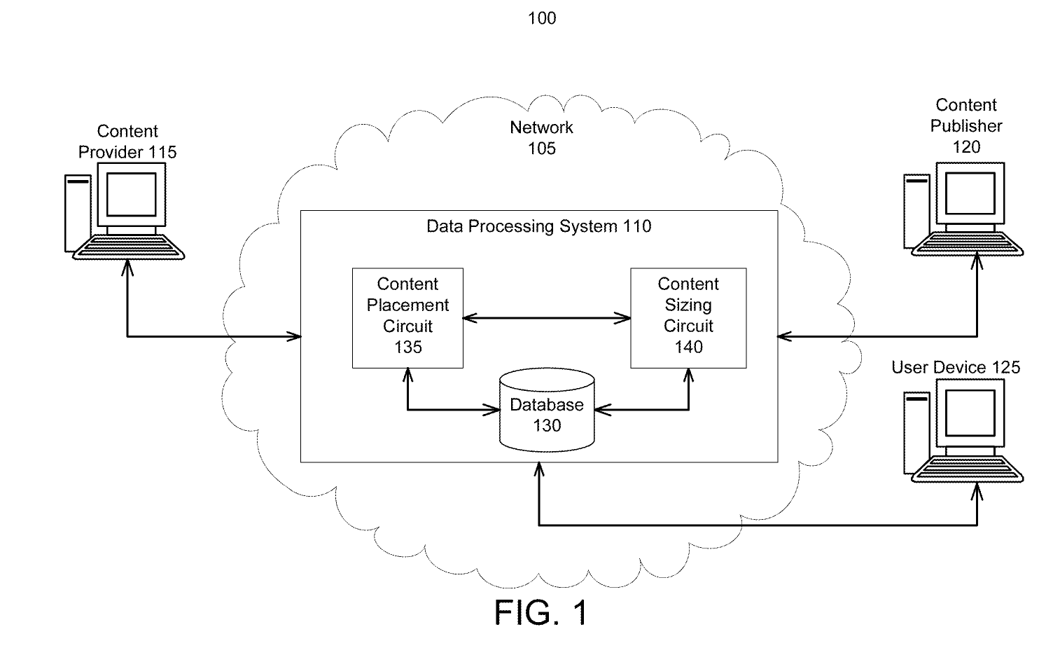

FIG. 1 illustrates an example system 100 of configuring content display dimensions of a resource. In one implementation, the source is a web page. Components of the system 100 can communicate via at least one computer network such as the network 105. The network 105 can include computer networks such as the Internet, local, wide, metro or other area networks, intranets, and other computer networks such as voice or data mobile phone communication networks.

The system 100 can also include at least one data processing system 110. The data processing system 110 can include at least one logic device such as a computing device having a processor to communicate via the network 105, for example with at least one content publisher 120 (e.g., a web page server), at least one user device 125, and at least one content provider 115 (e.g., an advertiser). The data processing system 110 can include at least one content placement circuit 135, at least one content sizing circuit 140, and at least one database 130. In one implementation, the data processing system 110 can include an ad placement system. The data processing system 110 can also include one or more servers. The content placement circuit 135 and the content sizing circuit 140 can each include at least one processor or other logic device to communicate with each other or the database 130. The content placement circuit 135 and the content sizing circuit 140 can be separate components, or an integrated part of the data processing system 110. In one implementation, a processor or other logic device of the user device 125 or the content publisher 120 includes the content placement circuit 135 or the content sizing circuit 140. For example, the content sizing circuit 140 can be part of the data processing system 110 that is part of the user device 125 and can execute a script at the user device 125 as described further herein.

The user device 125 can include computing devices such as a computer, laptop, desktop, smart phone, tablet, personal digital assistant, or server device configured to communicate with other devices via the network 105. The user device 125 can execute a software application (e.g., a web browser or other application) to retrieve content from other computing devices over network 105.

The content publisher 120 can include a computer having a server configured to host at least one web page. For example, the content publisher 120 may be a computer server (e.g., an FTP server, file sharing server, web server, etc.) or a combination of servers (e.g., a data center, a cloud computing platform, etc.). The content publisher 120 can provide webpage data or other content (e.g., text documents, PDF files, and other forms of electronic documents) to the user device 125. In one implementation, the user device 125 can communicate with the content publisher 120 via the network 105 to request access to a web page of the content publisher 120. Portions of the web page can be dedicated for content such as advertisements.

In one implementation, the data processing system 110 receives, via the network 105, a request for content to display in a content item slot of a resource. For example, the content placement circuit 135 can be configured to receive a request for content to display in a content item slot of a resource from the content publisher 120 or the user device 125. In one implementation, the resource is a web page. The content publisher 120 may include an operator of a web site, who may have an agreement with the data processing system 110 for the system to provide content (e.g., advertisements) to display on the web pages of the content publisher 120. In some implementations, the content publisher 120 can make a request to the data processing system 110 for advertisements to display on a web page rendered at the user device 125. The content publisher 120 can send web page data with advertisement data received from the data processing system 110 to the user device 125. The user device 125 may be a computing device operated by a user (represented by a user identifier). In some implementations, the user device 125, when accessing the web page of the content publisher 120, can make a request to the data processing system 110 for advertisements to display on the web page.

The activity of users on the network 105 can be maintained in an anonymous fashion so that individuals cannot be identified from the user activity. Furthermore, the user activity information can be collected on an opt-in basis, and users can opt out of the collection of their user activity information. The user can be represented by identifiers associated with a computing device, for example using a cookie without regard to the actual identity of the individual person using the computing device.

In one implementation, the data processing system 110 can determine, from the request, dimensions of the content item slot. For example, the content placement circuit 135 can determine an area of a web page that is made available by the content publisher 120 for displaying content such as advertisements. In one implementation, when the data processing system 110 receives a request for advertisements, the dimensions of the content item slot can be indicated in the request. For example, a request for content to display with a web page can include the following parameters:
ad_width=‘200’;
ad_height=‘200’;
ad_format=‘200×200_as’;
ad_type=‘text’;
ad_text_font_size=“11 px”.

The data processing system 110 can evaluate this information to determine that the dimensions of the content item slot are width=200 pixels and height=200 pixels.

In one implementation, the content publisher 120 can utilize a HTML iframe element to render the content. For example, when the data processing system 110 receives the request for content, a HTML iframe can be received at the data processing system 110. A HTML iframe element can be used to display a web page within another web page. For example, if the content item slot is implemented using the iframe element, the web page of the content publisher 120 can be identified as the bigger or parent web page, and the content item slot can be identified as the smaller or child web page. The HTML iframe can be created by a piece of script code provided by the data processing system 110. This piece of script code can be included in the web page by the content publisher 120. When the script code is executed at the user's browser, for example, an iframe can be created. The iframe can include a uniform resource locator (URL) of the ad placement system of the data processing system 110. For example, an iframe can be created using the iframe tag:
<iframe src=http://www.adserverexample.com/ads.htm width=“200” height=“200”></iframe>.

In one implementation, the data processing system 110 can select a suitable advertisement or other content for display with the web page from an ad repository such as database 130. For example, the data processing system 110 can select an advertisement based at least in part on the parameters of the content item slot received. For example, if the dimensions of the content item slot are “200 px×200 px”, the ad placement system may attempt to locate an advertisement based on these dimensions. In one implementation, the advertisement can be stored at the content publisher 120 and selected by the data processing system 110 for display with the web page.

In one implementation, the data processing system 110 identifies an advertisement or other content with dimensions that are smaller than those of the content item slot. For example, the data processing system 110 may determine that an advertisement with content similar to the web page but having different dimensions than the content item slot is more suitable than an advertisement with the same dimensions as the content item slot but having different content than the web page. For instance, the data processing system 110 may determine that a golf club advertisement with the dimensions of 200 px×170 px is more suitable for display in a 200 px×200 px content item slot on a web page devoted to golf than another advertisement with the dimensions of 200 px×200 px but that is unrelated to golf

In one implementation, responsive to the request, the content placement circuit 135 can identify content such as an advertisement to select for display in the content item slot. The content may also include computer implemented instructions, such as HTML code or JavaScript™ code, to be executed at the web page. For example, the HTML code or JavaScript™ code can measure the dimensions of the advertisement rendered in the browser of the user device 125. The data processing system 110 can evaluate this information to determine whether the dimensions of the advertisement are greater than or smaller than the dimensions of the content item slot.

In one implementation, the content provided by the data processing system 110 for display with the web page can be included in the iframe. For example, the iframe can be received from the content publisher 120 or the user device 125 when the data processing system 110 receives the request for content. The data processing system 110 can insert a script (e.g., JavaScript™ code) or HTML code into the iframe. The script or HTML code can be configured to execute at the web page.

The data processing system 110 can determine, based on information received from execution of the script, that the dimensions of the content item slot are greater than the dimensions of the content. For example, the content sizing circuit 140 can determine that the dimensions of the content item slot are greater than the dimensions of the content. In one implementation, the content sizing circuit 140 can compare the dimensions of the content item slot with the dimensions of the advertisement. In one implementation, the dimensions of the advertisement can be determined by the content sizing circuit 135 at the data processing system 110 before the advertisement is provided to the content publisher 120 or the user device 125.

In some implementations, the content placement circuit 135 or the content sizing circuit 140 of the data processing system 110 can be located at or part of the user device 125 or the content publisher 120. For example, the data processing system 110 can communicate with the content placement circuit 135 via the network 105 as part of an overall ad placement system. In this example, the script can be executed by the content sizing circuit 140, which can include logic devices of the user device 125 or the content publisher 120. The script can be included in the iframe and can be executed at the web page. In some implementations, the data processing system 110 determines dimensions of the advertisement based on information received from execution of the script at the user device 125 by the content sizing circuit 140 operating on hardware of the user device 125.

The data processing system 110 can adjust the dimensions of the content item slot based on the dimensions of the advertisement or other content. For example, the content sizing circuit 140 can adjust the dimensions of the content item slot. For example, the dimensions of the content item slot may be configured or reduced to match the dimensions of the content when the dimensions of the content item slot are greater than the dimensions of the advertisement. For example, if the dimensions of the content item slot is 200 px×200 px and the dimensions of the advertisement is 200 px×170 px, the dimensions of the content item slot can be reduced to 200 px×170 px.

In another implementation, the dimensions of the content item slot may be adjusted based on determined criteria when the dimensions of the content item slot are smaller than the dimensions of the content. For example, the determined criteria can be part of an agreement between operators of the data processing system 110 and the content publisher 120 that specifies how the data processing system 110 operates in the event that the dimensions of the content item slot are smaller than the dimensions of the content. In this example, some content publishers 120 may not want the dimensions of the content item slot to be adjusted (expanded) to match the dimensions of the advertisement because, as a result of the expansion, the portion of the web page covered by ads increases and part of the content of the web page can be covered by the content item slot. However, some content publishers 120 may allow the data processing system 110 to expand the dimensions of the content item slot by a certain amount of pixels. For example, a content publisher may allow the data processing system 110 to expand the content item slot by a small determined area, such as a space of 10 px×10 px or less because there might be extra space around the content item slot on some web pages.

In one implementation, the data processing system 110 adjusts the dimensions of the content item slot by calling a resizing application programming interface (“API”). For example, the content sizing circuit can call a resizing API to adjust the dimensions of the content item slot. The resizing API can be computer implemented instructions (e.g., JavaScript™ code) configured to receive (or listen to) a request (or message) for adjusting the size of a content item slot embedded in an iframe. In this example, the request can be sent as a result of the execution of the script within the iframe through a communication channel between the web page and the iframe. In one implementation, the content placement circuit 135 can retrieve the resizing API from the database 130 and provide the resizing API to the browser of the user device 125. The content sizing circuit 140 can execute the resizing API to adjust the dimensions of the content item slot based on the dimensions of the advertisement. For example, the content sizing circuit 140 can execute the resizing API to reduce the dimensions of the content item slot to match the dimensions of the advertisement.

The data processing system 110 can divide the content item slot into a first content item slot and a second content item slot. For example, the content sizing circuit 140 can divide the ad slot into two ad slots. The division of the ad slot can be based on the information received from the execution of the script and the dimensions of the content. For example, the content placement circuit 135 may select two (or more) advertisements for display in the content item slot of the web page. In this example, the script included in the iframe can be configured to send a request to the resizing API for dividing the ad slot into two (or more) ad slots. The content sizing circuit 140 can execute the resizing API to divide the content item slot into two (or more) content item slots based on the dimensions of each advertisement. The data processing system 110 can display each advertisement in its corresponding content item slot.

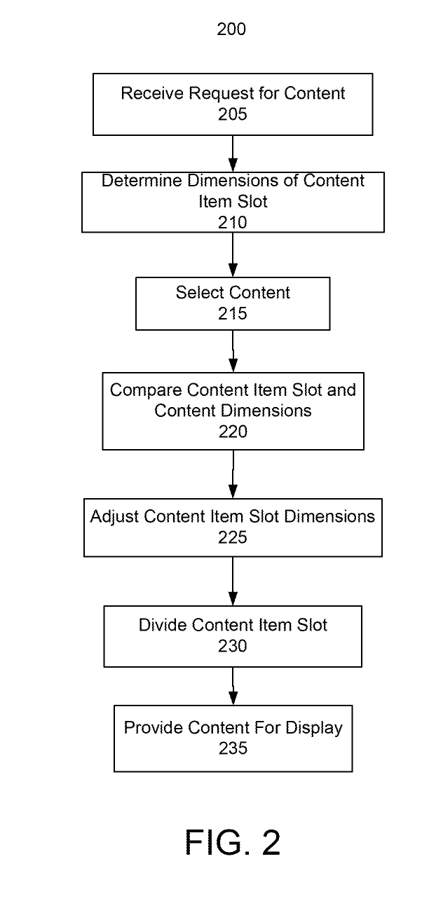

FIG. 2 illustrates a flow diagram depicting a method 200 of configuring content display dimensions via a computer network. The method 200 can receive a request for content to display in a content item slot of a web page via a network (BLOCK 205). For example, a data processing system having a content sizing circuit can receive a request (BLOCK 205) from a user device or a content publisher. In one implementation, the received request includes a request for an advertisement for display in the content item slot of the web page.

The method 200 can determine dimensions of the content item slot (BLOCK 210). For example, from information received in the request (BLOCK 205), the content placement circuit can determine the dimensions of the content item slot (BLOCK 210). In one implementation, the dimensions of the content item slot are sent in the request from the content publisher or the user device to the data processing system. For example, the dimensions of the content item slot can be provided in the format of ad_width=‘200’ and ad_height=‘200’. The dimensions of the content item slot can be expressed in units of pixels, for example.

The method 200 can select content for display in the content item slot (BLOCK 215). For example, the content placement circuit 135 can identify an advertisement from an ad repository such as a database. The criteria to identify the advertisement can include the dimensions of the content item slot. For example, the content placement circuit can identify an advertisement with dimensions that are less than or equal to the dimensions of the content item slot, and provide this content for display with the web page. In one implementation, responsive to the request for content, the content placement circuit can identify content for display in the content item slot of the web page (BLOCK 215). The content can include an advertisement and additional information such as a script (e.g., JavaScript™) configured to execute at the web page. For example, the script, when executed, can determine the dimensions of the advertisement rendered in the browser of the user device. The script can also be executed to determine that the dimensions of the content item slot are greater than, less than, or equal to the dimensions of the advertisement.

In one implementation, the content publisher can use a HTML iframe to display the advertisement with a web page. In this implementation, the iframe can be included in the request for content (BLOCK 205) received at the data processing system. When the content placement circuit provides the advertisement for display in the content item slot (BLOCK 215), the advertisement can be embedded in the iframe. The content placement circuit can also insert the script into the iframe for execution at the web page.

The method 200 can compare the content item slot dimensions with dimensions of the content (BLOCK 220). For example, the content sizing circuit can determine that the dimensions of the content item slot are greater than the dimensions of the content (BLOCK 220) based on information obtained by the script during execution. In one implementation, the data processing system executes the script to determine the dimensions of the advertisement rendered. From the information received from the execution of the script, the content sizing circuit can compare the dimensions of the advertisement with the dimensions of the content item slot.

The method 200 can adjust the dimensions of the content item slot based on the dimensions of the content (BLOCK 225). For example, the content sizing circuit can adjust the dimensions of the content item slot (BLOCK 225). In one implementation, the content sizing circuit can adjust the dimensions of the content by calling a resizing API. The resizing API can be configured to receive a request as a result of the execution of the script in the iframe, for example. The request can include dimensional information used to adjust the content item slot. The content sizing circuit can evaluate the information and execute the resizing API to adjust the content item slot. For example, the content sizing circuit can reduce the dimensions of the content item slot to match the dimensions of the content.

In some implementations, the method 200 can determine that the dimensions of the content item slot are smaller than the dimensions of the content (BLOCK 220). For example, the content sizing circuit can compare the content item slot and the content dimensions and determine that the content item slot is smaller than the advertisement (BLOCK 220). In this example, the method 200 can adjust the dimensions of the content item slot based on determined criteria or rules (BLOCK 225) such as an agreement between the content publisher and the ad placement system.

In some implementations, the method 200 can divide the content item slot into at least two content item slots (BLOCK 230). For example, the content sizing circuit can divide the content item slot (BLOCK 230) into a first content item slot and a second content item slot based on the information obtained from execution of the script and the dimensions of the content. In one implementation, the script included in the iframe can be configured to send a request to the resizing API to request dividing the content item slot. The content sizing circuit can execute the resizing API to divide the content item slot into a first content item slot and a second content item slot (BLOCK 230). The data processing system can provide the advertisement as the first advertisement to display in the first content item slot (BLOCK 235). The data processing system can also provide a second advertisement for display in the second content item slot (BLOCK 235).

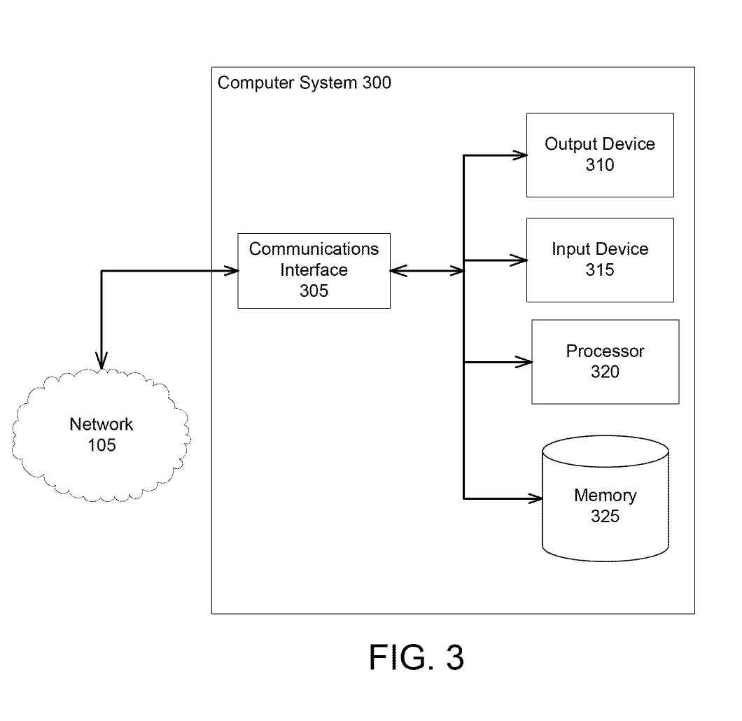

FIG. 3 shows the general architecture of an illustrative computer system 300 that may be employed to implement any of the computer systems discussed herein (including the system 100 and its components such as the content placement circuit 135 and the content sizing circuit 140) in accordance with some embodiments. The computer system 300 can be used to provide information via the network 105. The computer system 300 of FIG. 3 comprises one or more processors 320 communicatively coupled to memory 325, one or more communications interfaces 305, and one or more output devices 310 (e.g., one or more display units) and one or more input devices 315. The processors 320 can be included in data processing system 110 or the other components of the system 100 (such as the content placement circuit 135 and the content sizing circuit 140).

In the computer system 300 of FIG. 3, the memory 325 may comprise any computer readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the content placement circuit 135 and the content sizing circuit 140 can include the memory 325 to store the advertisement for display at the web page as well as the script code configured to be executed at the web page. The processor(s) 320 shown in FIG. 3 may be used to execute instructions stored in the memory 325 and, in so doing, also may read from or write to the memory various information processed and or generated pursuant to execution of the instructions.

The processor 320 of the computer system 300 shown in FIG. 3 also may be communicatively coupled to or control the communications interface(s) 305 to transmit or receive various information pursuant to execution of instructions. For example, the communications interface(s) 305 may be coupled to a wired or wireless network, bus, or other communication means and may therefore allow the computer system 300 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 300. Examples of communications interfaces 305 include user interfaces (e.g., web pages) having content (e.g., advertisements) selected by the content placement circuit 135 and provided by the content provider 115 for placement on the web pages.

The output devices 310 of the computer system 300 shown in FIG. 3 may be provided, for example, to allow various information to be viewed or otherwise perceived in connection with execution of the instructions. The input device(s) 315 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Embodiments of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The term “data processing apparatus,” “data processing system,” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The content placement circuit 135 and the content sizing circuit 140 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 300 or system 100 can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of the systems and methods described herein. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. For example, the content placement circuit 135 and the content sizing circuit 140 can be a single module, a logic device having one or more processing circuits, or part of a search engine.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the embodiment may be included in at least one implementation or embodiment.

Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of configuring content display dimensions via a computer network, comprising:
receiving, by at least one data processing system having a content sizing circuit, a request for content to display in a content item slot of a resource;
determining, from the request, dimensions of the content item slot;
selecting content, responsive to the request, for display in the content item slot, wherein the content includes a script configured to execute at the resource;
determining, based on information received from execution of the script, that the dimensions of the content item slot are greater than dimensions of the content; and
adjusting the dimensions of the content item slot based on the dimensions of the content.

2. The method of claim 1, further comprising:
dividing the content item slot into a first content item slot and a second content item slot based on the information received from the execution of the script and based on the dimensions of the content.

3. The method of claim 2, wherein the content is a first advertisement, further comprising:
providing the first advertisement for display in the first content item slot; and
providing a second advertisement for display in the second content item slot.

4. The method of claim 1, further comprising:
determining that the dimensions of the content item slot are smaller than the dimensions of the content; and
adjusting the dimensions of the content item slot based at least in part on determined criteria.

5. The method of claim 1, wherein the request includes an iframe, wherein the resource includes a web page, and wherein the content includes an advertisement, further comprising:
providing the advertisement for display in the content item slot, wherein the advertisement is embedded in the iframe, and wherein the iframe includes the script configured to execute at the web page;
determining that the dimensions of the content item slot are greater than dimensions of the advertisement; and
adjusting the dimensions of the content item slot based on the dimensions of the advertisement.

6. The method of claim 1, further comprising:
reducing the dimensions of the content item slot to match the dimensions of the content.

7. The method of claim 1, further comprising:
adjusting the dimensions of the content item slot by calling a resizing application programming interface;
evaluating, using the resizing application programming interface, the information received from execution of the script to identify a request to adjust the dimensions of the content item slot; and
adjusting the dimensions of the content item slot to match the dimensions of the content.

8. A system of configuring content display dimensions via a computer network, comprising:
a data processing system having a content placement circuit and a content sizing circuit, the data processing system configured to:
receive a request for content to display in a content item slot of a resource;
determine, from the request, dimensions of the content item slot;
select content, responsive to the request, for display in the content item slot, wherein the content includes a script configured to execute at the resource;
determine, based on information received from execution of the script, that the dimensions of the content item slot are greater than dimensions of the content; and
adjust the dimensions of the content item slot based on the dimensions of the content.

9. The system of claim 8, further comprising the data processing system configured to divide the content item slot into a first content item slot and a second content item slot based on the information received from the execution of the script and based on the dimensions of the content.

10. The system of claim 9, wherein the content is a first advertisement, further comprising the data processing system configured to:
select the first advertisement for display in the first content item slot; and
select a second advertisement for display in the second content item slot.

11. The system of claim 8, further comprising the data processing system configured to:
determine that the dimensions of the content item slot are smaller than the dimensions of the content; and
adjust the dimensions of the content item slot based at least in part on determined criteria.

12. The system of claim 8, wherein the request includes an iframe, wherein the resource includes a web page, and wherein the content includes an advertisement, further comprising the data processing system configured to:
select the advertisement for display in the content item slot, wherein the advertisement is embedded in the iframe, and wherein the iframe includes the script configured to execute at the web page;
determine that the dimensions of the content item slot are greater than dimensions of the advertisement; and
adjust the dimensions of the content item slot based on the dimensions of the advertisement.

13. The system of claim 8, further comprising the data processing system configured to reduce the dimensions of the content item slot to match the dimensions of the content.

14. The system of claim 8, further comprising the data processing system configured to:
adjust the dimensions of the content item slot by calling a resizing application programming interface, wherein the resizing application programming interface is configured to:
listen to a message sent from the script, wherein the message requests adjustment of the dimensions of the content item slot; and
adjust, responsive to the message, the dimensions of the content item slot to match the dimensions of the content.

15. A computer readable storage medium having instructions to configure content display dimensions on a computer network, the instructions comprising instructions to:
receive a request for content to display in a content item slot of a resource;
determine, from the request, dimensions of the content item slot;
select content, responsive to the request, for display in the content item slot, wherein the content includes a script configured to execute at the resource;
determine, based on information received from execution of the script, that the dimensions of the content item slot are greater than dimensions of the content; and
adjust the dimensions of the content item slot based on the dimensions of the content.

16. The computer readable storage medium of claim 15, further comprising instructions to:
divide the content item slot into a first content item slot and a second content item slot based on the information received from the execution of the script and based on the dimensions of the content.

17. The computer readable storage medium of claim 16, wherein the content is a first advertisement, further comprising instructions to:
select the first advertisement for display in the first content item slot; and
select a second advertisement for display in the second content item slot.

18. The computer readable storage medium of claim 15, further comprising instructions to:
determine that the dimensions of the content item slot are smaller than the dimensions of the content; and
adjust the dimensions of the content item slot based at least in part on determined criteria.

19. The computer readable storage medium of claim 15, wherein the request includes an iframe, wherein the resource includes a web page, and wherein the content is an advertisement, further comprising instructions to:
select the advertisement for display in the content item slot, wherein the advertisement is embedded in the iframe, wherein the iframe includes the script configured to execute at the web page;
determine that the dimensions of the content item slot are greater than dimensions of the advertisement; and
adjust the dimensions of the content item slot based on the dimensions of the advertisement.

20. The computer readable storage medium of claim 15, further comprising instructions to:
reduce the dimensions of the content item slot to match the dimensions of the content.
